(19) United States
(12) Patent Application Publication
(10) Pub. No.: US 2026/0058719 A1
(43) Pub. Date: Feb. 26, 2026

(54) METHODS TO PERFORM CELL MEASUREMENTS WHILE DEVICES OF A NON-TERRESTRIAL NETWORK ARE IN A CONNECTED STATE

(71) Applicant: Telefonaktiebolaget LM Ericsson (publ), Stockholm (SE)

(72) Inventors: Ignacio Javier PASCUAL PELAYO, Stockholm (SE); Emre YAVUZ, Stockholm (SE)

(21) Appl. No.: 19/102,608

(22) PCT Filed: Aug. 10, 2023
(86) PCT No.: PCT/EP2023/072202

§ 371 Date: Feb. 10, 2025

Related U.S. Application Data
(60) Provisional application No. 63/396,808, filed on Aug. 10, 2022.

(51) Int. Cl. H04B 7/185

(52) U.S. Cl. CPC H04B 7/18513

(57) ABSTRACT

A method, system and apparatus are disclosed. A method in a wireless device (WD) configured to communicate with a network node of a non-terrestrial network (NTN) using a connection via one or more cells served by the network node is described. The method includes receiving, from the network node, information usable to perform one or more actions associated with maintaining the connection via the one the one or more cells and performing the one or more actions associated with maintaining the connection via the one the one or more cells based at least in part on the received information. The one or more actions include selecting one or more cells in advance of a radio link failure associated with the connection.

### TECHNICAL FIELD

The present disclosure relates to wireless communications, and in particular, to cell measurements associated with internet of things (IoT) devices and non-terrestrial networks (NTN).

### BACKGROUND

The Third Generation Partnership Project (3GPP) has developed and is developing standards for Fourth Generation (4G) (also referred to as Long Term Evolution (LTE)), Fifth Generation (5G) (also referred to as New Radio (NR)), and Sixth Generation (6G) wireless communication systems. Such systems provide, among other features, broadband communication between network nodes, such as base stations, and mobile wireless devices (WD) such as user equipment (UE), as well as communication between network nodes and between WDs.

The components of wireless communication systems, such as network nodes and WDs, may be configured to support Machine-to-Machine (M2M) and/or Internet of Things (IoT) features. Recently, there has been discussions in 3GPP about how to specify technologies to cover/address use cases for M2M and/or IoT. In 3GPP Release 13 (i.e., Rel-13) enhancements to support Machine-Type Communications (MTC) were specified by introducing WD, e.g., UE, categories MTC 1 (Cat-M1) and narrow band 1 (NB1) (Cat-NB1). The introduced WD, e.g., UE, categories (the broader term WD and the 3GPP categories are referred to herein as “UE categories” for ease of understanding with respect to 3GPP standardization, but it is understood that these categories are not limited to WDs in the strict sense of the definition) may serve to support reduced maximum bandwidth of up to six physical resource blocks (PRBs) in enhanced MTC (eMTC) work item and narrowband carrier in narrow band IoT (NB-IoT) work item, thereby specifying a new radio interface, respectively.

With respect to LTE, there are multiple differences between “legacy” LTE and the procedures and channels defined for eMTC or NB-IoT. Some important differences include a physical downlink control channel, i.e., MTC physical downlink control channel (MPDCCH) used in eMTC, NB PDCCH (NPDCCH) used in NB-IoT.

### eMTC

3GPP Release 12 (Rel-12) initiated the work on eMTC, also often referred to as LTE-M, and specified the first low-complexity UE category 0 (Cat-0). Cat-0 supports a reduced peak data rate of 1 Mbps, single antenna and half duplex frequency division duplex (HD FDD) operation.

Further, in 3GPP Rel-13, the work accelerated with the introduction of the Cat-M1 UE category, which supports a further reduced complexity and coverage enhanced (CE) operation. Additional cost reduction came from a reduced transmission and reception bandwidth of 1.08 MHz, equivalent to six 180 kHz physical resource blocks (PRBs). The introduction of a lower WD power class of 20 dBm, in addition to the 23 dBm power class, further facilitates a lower WD complexity.

Because of the reduction in bandwidth, a new narrowband physical downlink control channel, the MTC physical downlink control channel (MPDCCH), was introduced as a substitute for the wideband legacy physical downlink control channel (PDCCH) and the Enhanced PDCCH (EPDCCH). Cat-MI WDs may monitor MPDCCH in a narrowband (NB), which may be defined by six adjacent PRBs.

Further, eMTC supports an MCL that is 20 dB larger than the normal MCL of LTE. This is achieved mainly through time repetition and a relaxed acquisition time of the physical channels and signals. The primary and secondary synchronization signals (PSS and SSS) are fully reused from LTE, and extended coverage is achieved by means of increased acquisition time.

For the physical broadcast channel (PBCH), the MPDCCH, the physical uplink control channel (PUCCH) and the data channels (i.e., physical uplink shared channel (PUSCH) and physical downlink shared channel (PDSCH)), the desired coverage enhancement may be achieved through time repetition of a transmission block.

In 3GPP LTE Release 14 (Rel-14) and 3GPP LTE Release 15 (LTE Rel-15), eMTC was further enhanced to support a more diversified set of applications and services. A UE category Cat-M2 was specified. The performance of eMTC in LTE Rel-15 meets the IMT-2020 5G requirements for the massive IoT use case. Further, the work in 3GPP on eMTC was continued in 3GPP Release 16 (Rel-16) and is further evolved also in 3GPP Release 17 (Rel-17).

### NB-IoT

At the 3GPP RAN #70 meeting, a new 3GPP Rel-13 work item named narrowband IoT (NB-IoT) was approved. An objective of the new IoT related work items approved for Rel-13 was to specify a radio access for cellular internet of things (IoT) that addresses improved indoor coverage, support for massive number of low throughput devices, not sensitive to delay, ultra-low device cost, low device power consumption and (optimized) network architecture.

NB-IoT may be described as a narrowband version of LTE. Similar to eMTC, NB-IoT makes use of increased acquisition times and time repetitions to extend the system coverage. The repetitions can be seen as a third level of retransmissions added at the physical layer as a complement to those at medium access control (MAC) hybrid automatic repeat request (HARQ) and radio link control (RLC) automatic repeat request (ARQ). A NB-IoT downlink carrier may be defined by twelve orthogonal frequency division multiplex (OFDM) sub-carriers, each of 15 kHz, giving a total baseband bandwidth of 180 kHz. When multiple carriers are configured, several 180 kHz carriers may be used, e.g., for increasing the system capacity, inter-cell interference coordination, load balancing, etc. This design gives NB-IoT a high deployment flexibility:

NB-IoT may support three different deployment scenarios or mode of operations:
1. ‘Stand-alone operation’ utilizing for example the spectrum currently being used by global system for mobile communications (GSM)/enhanced data for GSM evolution (EDGE) radio access network (GERAN) systems as a replacement of one or more GSM carriers. In principle, it operates on any carrier frequency which is neither within the carrier of another system nor within the guard band of another system operating carrier. The other system can be another NB-IoT operation or any other radio access technology (RAT) such as LTE.
2. ‘Guard band operation’ utilizing the unused resource blocks within an LTE carrier's guard-band. The term guard band may also interchangeably be referred to as guard bandwidth. As an example, in cases of LTE bandwidth (BW) of 20 MHz (i.e., Bwl=20 MHz or 100 resource blocks (RBs)), the guard band operation of NB-IoT can place anywhere outside the central 18 MHz but within 20 MHz LTE BW.
3. ‘In-band operation’ utilizing resource blocks within a normal LTE carrier. The in-band operation may also interchangeably be called in-bandwidth operation. More generally, the operation of one RAT within the BW of another RAT may also be referred to as in-band operation. As an example, in an LTE BW of 50 RBs (e.g., Bwl=10 MHz or 50 RBs), NB-IoT operation over one resource block (RB) within the 50 RBs may be called in-band operation.

### Anchor Carrier and non-Anchor Carrier in NB-IoT

In NB-IoT, anchor and non-anchor carriers are defined. In anchor carrier, the WD assumes anchor specific signals including NB primary synchronization signal (NPSS), NB secondary synchronization signal (NSSS), NB physical broadcast channel (NPBCH), and/or system information block NB (SIB-NB) that may be transmitted on downlink. In non-anchor carrier, the WD may be configured to not assume that NPSS/NSSS/NPBCH/SIB-NB are transmitted on the downlink (DL). The anchor carrier may be transmitted on at least subframes #0, #4, #5 in every frame and subframe #9 in every other frame. Additional DL subframes in a frame can also be configured on anchor carrier by means of a DL bit map. The anchor carriers transmitting NPBCH/SIB-NB may also include also NB reference signal (NRS). The non-anchor carrier may include NRS during certain occasions and WD specific signals such as NPDCCH and NPDSCH. NRS, NPDCCH and NPDSCH may also be transmitted on anchor carrier. The resources for non-anchor carrier may be configured by the network node. The non-anchor carrier can be transmitted in any subframe as indicated by a DL bit map. For example, the enhance Node B (eNB) signals a DL bit map of DL subframes using resource radio control (RRC) message (DL-Bitmap-NB) which are configured as non-anchor carrier. The anchor carrier and/or non-anchor carrier may typically be operated by the same network node e.g., by the serving cell. However, the anchor carrier and/or non-anchor carrier may also be operated by different network nodes.

### RLM Procedure in NB-IoT

In this section, the radio link monitoring (RLM) procedure in NB-IoT is described. However, this is provided as a reference for the rest of the discussion and other/similar aspects may apply also to eMTC. A purpose of RLM is to monitor the radio link quality of the serving cell of the WD and use that information to decide whether the WD is in in-sync or out-of-sync with respect to that serving cell. In LTE, RLM is carried out by the WD performing measurement on downlink reference symbols (CRS) in RRC_CONNECTED state. If results of radio link monitoring points at a certain number of consecutive out of sync (OOS) indications, the WD starts the RLF procedure and declares radio link failure (RLF) after the expiry of RLF timer (e.g., T310). The actual procedure is carried out by comparing the estimated downlink reference symbol measurements to some thresholds, Qout and Qin. Qout and Qin may correspond to Block Error Rate (BLER) of hypothetical control channel (e.g., NPDCCH) transmissions from the serving cell.

Examples of the target BLER corresponding to Qout and Qin are 10% and 2%, respectively. The radio link quality in RLM may be determined based on a reference signal (e.g., NRS), determined at least once every radio frame (when not configured with discontinuous reception (DRX)), determined periodically with DRX cycle (when configured with DRX), determined over the system bandwidth or control channel bandwidth (e.g., NPDCCH BW) for the WD, and/or determined over the WD bandwidth (e.g., 200 kHz).

T310 may refer to an RLF timer which starts when the WD detects physical layer problems for the PCell. More specifically, the RLF timer starts upon WD receiving N310 number of consecutive out-of-sync indications from its lower layers. When T310 expires, RLF is declared, but T310 is reset upon the WD receiving N311 number of consecutive in-sync indications from its lower layers. Upon RLF declaration (i.e., T310 expiration), the WD starts RRC connection re-establishment procedure and starts another timer T311. The RRC connection re-establishment procedure starts with cell selection, and T311 is reset if the WD finds and selects a suitable cell. Then, the WD sends an RRCReestablishementRequest message in the selected cell and starts timer T301. If the RRC connection reestablishment procedure is successful (indicated by an RRCReestablishment message from the network node such as an gNB), the WD stops/resets timer T301. If T311 expires before (because the WD failed to select a suitable cell), or if T301 expires (because the RRC connection reestablishment failed), then the WD goes to RRC_IDLE state and it may initiate cell selection. Parameters T310, T311, T301, N310 and N311 are configured by the PCell e.g., via RRC message. As an example, T310 can vary between 0 to 8000 ms, T311 can vary from 1000 ms to 30000 ms, N310 can be set from {1, 2, 3, 4, 6, 8, 10, 20}, and N311 can be set from {1, 2, 3, 4, 5, 6, 8, 10}.

FIG. 1 shows an example RLF and RRC connection re-establishment.

### Non-Terrestrial Networks (NTN)

In 3GPP Release 15 (Rel-15), the first release of the 5G system (5GS) was specified. This is a new generation radio access technology intended to serve use cases such as enhanced mobile broadband (eMBB), ultra-reliable and low latency communication (URLLC) and massive machine type communication (mMTC). 5G includes the New Radio (NR) access stratum interface and the 5G Core Network (5GC). The NR physical and higher layers are reusing parts of the LTE specification, and additional components are introduced when motivated by the new use cases.

In Rel-15, 3GPP also started the work to prepare NR for operation in a Non-Terrestrial Network (NTN). The work was performed within the study item “NR to support Non-Terrestrial Networks” and resulted in 3GPP Technical Report (TR) 38.811 V15.4.0. In Rel-16, the work to prepare NR for operation in an NTN network continues with the study item “Solutions for NR to support Non-Terrestrial Network”. In parallel, the interest in adapting LTE for operation in NTN is growing. As a consequence, 3GPP is considering introducing support for NTN in both LTE and NR in Rel-17.

### Satellite Communications

A satellite radio access network usually includes at least one of the following components:
A satellite that refers to a space-borne platform.
An earth-based gateway that connects the satellite to a base station or a core network, depending on the choice of architecture.
Feeder link that refers to the link between a gateway and a satellite
Access link that refers to the link between a satellite and a WD.

Depending on the orbit altitude, a satellite may be categorized as low earth orbit (LEO), medium earth orbit (MEO), or geostationary earth orbit (GEO) satellite.
LEO: typical heights ranging from 250-1,500 km, with orbital periods ranging from 90-120 minutes.
MEO: typical heights ranging from 5,000-25,000 km, with orbital periods ranging from 3-15 hours.
GEO: height at about 35,786 km, with an orbital period of 24 hours.

The significant orbit height means that satellite systems are characterized by a path loss that is higher (e.g., significantly higher) than what is expected in terrestrial networks. To overcome the pathloss, it is often required that the access and feeder links are operated in line-of-sight conditions, and that the WD is equipped with an antenna offering high beam directivity.

A communication satellite typically generates several beams over a given area. The footprint of a beam is usually in an elliptic shape, which has been traditionally considered as a cell. The footprint of a beam is also often referred to as a spotbeam. The spotbeam may move over the earth surface with the satellite movement or may be earth fixed with some beam pointing mechanism used by the satellite to compensate for its motion. The size of a spotbeam depends on the system design, which may range from tens of kilometers to a few thousands of kilometers. FIG. 2 shows an example architecture of a satellite network with bent pipe transponders.

The NTN beam may, in comparison to the beams observed in a terrestrial network, be very wide and cover an area outside of the area defined by the served cell. Beam covering adjacent cells may overlap and cause significant levels of intercell interference. To overcome the large levels of interference, a typical approach is an NTN to configure different cells with different carrier frequencies and polarization modes.

In a LEO NTN, the satellites are moving with a very high velocity. This leads to a Doppler shift of the carrier frequency on the service link of up to 24 ppm for a LEO satellite at 600 km altitude. The Doppler shift is also time variant due to the satellite motion over the sky. The Doppler shift may vary with up to 0.27 ppm/s for a LEO 600 km satellite. The Doppler shift may also impact, i.e., increase or decrease, the frequency received on the service link compared to the transmitted frequency. For GEO NTN, the satellites may move in an orbit inclined relative to the plane of the equator. The inclination introduces a periodic movement of the satellite relative earth, which introduces a predictable, daily periodically repeating Doppler shift of the carrier frequency as shown in the example in FIG. 3. More specifically, FIG. 3 shows an example of a diurnal Doppler shift of the forward service link observed for a GEO satellite operating from an inclined orbit. Throughout this disclosure, the terms beam and cell may be used interchangeably, unless explicitly noted otherwise.

### Ephemeris Data

3GPP TR 38.821 V.16.1.0 describes that ephemeris data should be provided to the WD, for example, to assist with pointing a directional antenna (or an antenna beam) towards the satellite. A WD knowing its own position, e.g., thanks to Global Navigation Satellite Systems (GNSS) support, may also use the ephemeris data to calculate correct Timing Advance (TA) and Doppler shift. The contents of the ephemeris data and the procedures on how to provide and update such data have not yet been studied in detail.

Further, a satellite orbit may be described (e.g., fully described) using one or more parameters (e.g., 6 parameters). Exactly which set of parameters is used may be decided by the user. Many different representations are possible. For example, a choice of parameters used often in astronomy is the set (a, ε, i, Ω, ω, t). Here, semi-major axis a and eccentricity & describe the shape and size of the orbit ellipse. Inclination i, the right ascension of the ascending node Ω, and the argument of periapsis ω determine its position in space. Epoch t determines a reference time (e.g., the time when the satellites moves through periapsis). These parameters (and orbital elements) are shown in the example of FIG. 4.

In addition, a two-line element set (TLE) is a data format encoding a list of orbital elements of an Earth-orbiting object for a given point in time, i.e., the epoch. As an example of a different parametrization, TLEs may use mean motion n and mean anomaly M instead of a and t. A completely different set of parameters may be the position and velocity vector (x, y, z, vx, vy, vz) of a satellite. These are sometimes called orbital state vectors and can be derived from the orbital elements and vice versa (since the information they contain is equivalent). These formulations (and many others) are possible choices for the format of ephemeris data to be used in NTN.

It is important that a WD can determine the position of a satellite with accuracy of at least a few meters. However, several studies have shown that this might be hard to achieve when using the de-facto standard of TLEs. On the other hand, LEO satellites often have GNSS receivers and can determine their position with some meter level accuracy.

Another aspect, discussed during the study item and captured in 3GPP TR 38.821, is the validity time of ephemeris data. Predictions of satellite positions in general degrade with increasing age of the ephemeris data used, due to atmospheric drag, maneuvering of the satellite, imperfections in the orbital models used, etc. Therefore, the publicly available TLE data are updated quite frequently. The update frequency depends on the satellite and its orbit and ranges from weekly to multiple times a day for satellites on very low orbits which are exposed to strong atmospheric drag and need to perform correctional maneuvers often. In other words, while it seems possible to provide the satellite position with the required accuracy, care needs to be taken to meet these requirements, e.g., when choosing the ephemeris data format, or the orbital model to be used for the orbital propagation.

Additionally, ephemeris data includes at least five parameters describing the shape and position in space of the satellite orbit. It also comes with a timestamp, which is the time when the other parameters describing the orbit ellipse were obtained. The position of the satellite at any given time in the nearer future can be predicted from this data using orbital mechanics. The accuracy of this prediction may however degrade as one projects further and further into the future. The validity time of a certain set of parameters depends on many factors like the type and altitude of the orbit, but also the desired accuracy, and ranges from the scale of a few days to a few years.

Further, in typical NB-IoT, mobility can only be triggered by RLF in connected mode. A NB-IoT WD may search for a cell after RLF is declared to initiate the RRC connection re-establishment procedure. This applies to both user plane and control plane solutions. The procedure allows the retrieval of the WD context and the recovery of undelivered data. For NB-IoT WDs that are mobile, i.e., not stationary or do not have low mobility, it may be beneficial for the WD to reduce the time it takes to perform RRC reestablishment to another cell to avoid service interruption. In 3GPP Rel-17, a mechanism is introduced to assist a NB-IoT WD regarding when it is more likely to declare RLF and how to perform the cell search, especially when inter-frequency cells are considered. The network (e.g., network node) provides criteria so that neighbor cell measurements are triggered only when RLF is to be declared due to “mobility”. The criterion to start cell measurements for this purpose is based on a combination of serving cell quality threshold and variance. Legacy relaxed monitoring criteria may be used as a baseline to address the variance part of the criteria.

With respect to power thresholds, the criteria (i.e., reference signal receive power (RSRP) thresholds) to start performing the measurements are signaled separately for intra-and inter-frequency measurements via broadcast signaling. Since dedicated measurements gaps are not supported, the WD may need to perform neighbor cell measurements during DL/UL idle periods that are provided by DRX or packet scheduling. The procedure may be intended for “mobile” NB-IoT WDs, which is ensured by applying a criteria similar to what has been introduced for relaxed monitoring.

In 3GPP Release 18 (Rel-18), the following objective has been described in a follow up WI for IoT NTN: “Support of neighbor cell measurements and corresponding measurement triggering before RLF, using Rel 17 (TN) NB-IoT, eMTC as a baseline”.

The mechanism introduced in Rel-17 is intended for “mobile” WDs, as mentioned above, yet WDs in an NTN, regardless of whether they are stationary or mobile, can be considered mobile with respect to the satellites. This applies to an NTN scenario either with earth fixed cells or earth moving cells. Another aspect to consider is the change in RSRP measurements as a WD moves closer to a cell border. In a terrestrial network, a rather significant drop of RSRP measurements can be observed when the WD is closer to a cell border, but this does not necessarily seem to be the case for NTN. Hence, the criteria to trigger neighbor cells measurements and corresponding measurement triggering need to be reconsidered within the context of NTN.

### SUMMARY

Some embodiments advantageously provide methods, systems, and apparatuses for cell measurements associated with internet of things (IoT) wireless devices (WDs) and/or network nodes operating in non-terrestrial networks (NTN). In some embodiments, the time it takes to re-establish the RRC connection for IoT WDs is reduced, e.g., by redefining criteria to trigger neighbor cell measurements and/or corresponding measurements within the context of NTN.

In some other embodiments, cell selection is accelerated, e.g., when compared to typical systems. In one or more embodiments, the cell selection process is performed, e.g., by performing neighbor cell measurements in advance when radio link failure is declared, which may lead to a reduction in overall service interruption compared to what can be achieved with the typical mechanism for IoT NTN.

In an embodiment, overall service interruption is reduced for IoT WDs in RRC_CONNECTED (i.e., a connected mode) during RLF followed by RRC connection re-establishment when compared typical mechanisms for IoT NTN. In another embodiment, a mechanism for NB-IoT WDs in a terrestrial network may be used in (applied to) IoT WDs in NTN. Although some embodiments focus on NTN in the context of IoT, the methods described may apply to any wireless network such as a wireless network dominated by line-of-sight conditions.

According to one aspect, a method in a wireless device (WD) configured to communicate with a network node of a non-terrestrial network (NTN) using a connection via one or more cells served by the network node is described. The method includes receiving, from the network node, information usable to perform one or more actions associated with maintaining the connection via the one the one or more cells and performing the one or more actions associated with maintaining the connection via the one the one or more cells based at least in part on the received information. The one or more actions include selecting one or more cells in advance of a radio link failure associated with the connection.

In some embodiments, the information includes a remaining service time indicating when a cell of the one or more cells that is serving the WD will stop serving the WD. The one or more actions include, when the WD is in a connected mode, one or both of determining, based on the remaining service time, to start a timer (T326) that indicates when the WD is to perform cell measurements during a connected mode and performing the cell measurements.

In some other embodiments, the one or more actions include, based on the remaining service time, one or both of adjusting the timer (T326) and skipping the performing of the cell measurements.

In some embodiments, the information includes a time threshold. The one or more actions include activating the timer (T326) when the WD receives the time threshold.

In some other embodiments, the information further includes satellite footprint information. The one or more actions include, based on the satellite footprint information, determining a proximity metric indicating a proximity of the WD to the cell and determining whether the WD is moving towards the cell. The one or more actions may include, based on the proximity metric and whether the WD is moving towards the cell, activating the timer (T326) and performing the cell measurements.

In some embodiments, when the cell is a quasi earth fixed cell, the satellite footprint information includes one or more of a first cell radius, a cell reference location, a second cell radius in an along-track direction and a third cell radius in a cross-track direction. The received information includes one or both of a first threshold indicating one or more of a distance from a reference location, a first time variance of the distance to the reference location, a second time variance between WD location measurements, a percentage of radius; and the reference location for neighboring cells and one or more distance thresholds. When the cell is an earth moving cell, the satellite footprint information includes one or more of a fourth cell radius and one or two elevation angles, the received information includes one or both of one or more elevation angles measured from the WD to a satellite and time variance of the one or more elevation angles.

In some other embodiments, the one or more actions include, based on the satellite footprint information and whether the cell is the quasi earth fixed cell or the earth moving cell and, one or more of activating the timer (T326), performing the cell measurements, and maintaining a reference power level without updates.

In some embodiments, the one or more actions include obtaining the satellite footprint information for the satellite and neighbor satellites when the WD experiences discontinuous coverage. If an upcoming coverage gap is not detected, the one or more actions include one or both of activating the timer (T326) and determining when to perform neighbor cell measurements.

In some other embodiments, the one or more actions include one or more of transmitting, to the network node, a request requesting the satellite footprint information of one or more close neighbor cells, where each one of the one or more close neighbor cells are at a distance from the cell that is less than a predetermined distance threshold, transmitting, to the network node, a WD location for the network node to select a list of the one or more close neighbor cells, and receiving a WD configuration including the predetermined distance threshold and a predetermined elevation angle threshold different from broadcasted in system information.

In some embodiments, the WD is an internet of things (IoT) NTN device, and the network node is an NTN satellite.

According to another aspect, a wireless device (WD) configured to communicate with a network node of a non-terrestrial network (NTN) using a connection via one or more cells served by the network node. The WD is configured to receive, from the network node, information usable to perform one or more actions associated with maintaining the connection via the one the one or more cells and perform the one or more actions associated with maintaining the connection via the one the one or more cells based at least in part on the received information. The one or more actions including selecting one or more cells in advance of a radio link failure associated with the connection.

In some embodiments, the information includes a remaining service time indicating when a cell of the one or more cells that is serving the WD will stop serving the WD. The one or more actions include, when the WD is in a connected mode, one or both of determining, based on the remaining service time, to start a timer (T326) that indicates when the WD is to perform cell measurements during a connected mode and performing the cell measurements.

In some other embodiments, the one or more actions include, based on the remaining service time, one or both of adjusting the timer (T326) and skipping the performing of the cell measurements.

In some embodiments, the information includes a time threshold. The one or more actions include activating the timer (T326) when the WD receives the time threshold.

In some other embodiments, the information further includes satellite footprint information. The one or more actions include, based on the satellite footprint information, determining a proximity metric indicating a proximity of the WD to the cell and determining whether the WD is moving towards the cell. The one or more actions may include, based on the proximity metric and whether the WD is moving towards the cell, activating the timer (T326) and performing the cell measurements.

In some embodiments, when the cell is a quasi earth fixed cell, the satellite footprint information includes one or more of a first cell radius, a cell reference location, a second cell radius in an along-track direction and a third cell radius in a cross-track direction. The received information includes one or both of a first threshold indicating one or more of a distance from a reference location, a first time variance of the distance to the reference location, a second time variance between WD location measurements, a percentage of radius; and the reference location for neighboring cells and one or more distance thresholds. When the cell is an earth moving cell, the satellite footprint information includes one or more of a fourth cell radius and one or two elevation angles, the received information includes one or both of one or more elevation angles measured from the WD to a satellite and time variance of the one or more elevation angles.

In some other embodiments, the one or more actions include, based on the satellite footprint information and whether the cell is the quasi earth fixed cell or the earth moving cell and, one or more of activating the timer (T326), performing the cell measurements, and maintaining a reference power level without updates.

In some embodiments, the one or more actions include obtaining the satellite footprint information for the satellite and neighbor satellites when the WD experiences discontinuous coverage. If an upcoming coverage gap is not detected, the one or more actions include one or both of activating the timer (T326) and determining when to perform neighbor cell measurements.

In some other embodiments, the one or more actions include one or more of transmitting, to the network node, a request requesting the satellite footprint information of one or more close neighbor cells, where each one of the one or more close neighbor cells are at a distance from the cell that is less than a predetermined distance threshold, transmitting, to the network node, a WD location for the network node to select a list of the one or more close neighbor cells, and receiving a WD configuration including the predetermined distance threshold and a predetermined elevation angle threshold different from broadcasted in system information.

In some embodiments, the WD is an internet of things (IoT) NTN device, and the network node is an NTN satellite.

According to another aspect, a method in a network node of a non-terrestrial network (NTN) configured to communicate with a wireless device (WD) using a connection via one or more cells served by the network node. The method includes determining information usable by the WD to perform one or more actions associated with maintaining the connection via the one the one or more cells. The one or more actions include selecting, by the WD, one or more cells in advance of a radio link failure associated with the connection. The information is determined based on parameters associated with the NTN. The method further includes transmitting the information to the WD.

In some embodiments, the information includes a remaining service time indicating when a cell of the one or more cells that is serving the WD will stop serving the WD, the remaining service time being usable by the WD for starting a timer (T326) that indicates when the WD is to perform cell measurements during a connected mode.

In some other embodiments, the information includes a time threshold usable by the WD for determining when to activate the timer (T326).

In some embodiments, the information further includes satellite footprint information usable by the WD for determining a proximity metric indicating a proximity of the WD to the cell, determining whether the WD is moving towards the cell, activating the timer (T326), and performing the cell measurements.

In some other embodiments, when the cell is a quasi earth fixed cell, the satellite footprint information includes one or more of a first cell radius, a cell reference location, a second cell radius in an along-track direction and a third cell radius in a cross-track direction; the transmitted information includes one or both of a first threshold indicating one or more of a distance from a reference location, a first time variance of the distance to the reference location, a second time variance between WD location measurements, a percentage of radius; and the reference location for neighboring cells and one or more distance thresholds.

In some embodiments, when the cell is an earth moving cell, the satellite footprint information includes one or more of a fourth cell radius and one or two elevation angles, and the transmitted information includes one or both of one or more elevation angles measured from the WD to a satellite, and time variance of the one or more elevation angles.

In some other embodiments, the method further includes receiving, from the WD, a request requesting the satellite footprint information of one or more close neighbor cells, each one of the one or more close neighbor cells being at a distance from the cell that is less than a predetermined distance threshold.

In some embodiments, the method further includes receiving, from the WD, a WD location and selecting a list of the one or more close neighbor cells based on the WD location.

In some other embodiments, the method further includes transmitting a WD configuration including the predetermined distance threshold and a predetermined elevation angle threshold different from broadcasted in system information.

In some embodiments, the WD is an internet of things, IoT, NTN device and the network node is an NTN satellite.

According to one aspect, a network node of a non-terrestrial network (NTN) configured to communicate with a wireless device (WD) using a connection via one or more cells served by the network node. The network node is configured to determine information usable by the WD to perform one or more actions associated with maintaining the connection via the one the one or more cells. The one or more actions include selecting, by the WD, one or more cells in advance of a radio link failure associated with the connection. The information is determined based on parameters associated with the NTN. The network node is further configured to transmit the information to the WD.

In some embodiments, the information includes a remaining service time indicating when a cell of the one or more cells that is serving the WD will stop serving the WD, the remaining service time being usable by the WD for starting a timer (T326) that indicates when the WD is to perform cell measurements during a connected mode.

In some other embodiments, the information includes a time threshold usable by the WD for determining when to activate the timer (T326).

In some embodiments, the information further includes satellite footprint information usable by the WD for determining a proximity metric indicating a proximity of the WD to the cell, determining whether the WD is moving towards the cell, activating the timer (T326), and performing the cell measurements.

In some other embodiments, when the cell is a quasi earth fixed cell, the satellite footprint information includes one or more of a first cell radius, a cell reference location, a second cell radius in an along-track direction and a third cell radius in a cross-track direction; the transmitted information includes one or both of a first threshold indicating one or more of a distance from a reference location, a first time variance of the distance to the reference location, a second time variance between WD location measurements, a percentage of radius; and the reference location for neighboring cells and one or more distance thresholds.

In some embodiments, when the cell is an earth moving cell, the satellite footprint information includes one or more of a fourth cell radius and one or two elevation angles, and the transmitted information includes one or both of one or more elevation angles measured from the WD to a satellite, and time variance of the one or more elevation angles.

In some other embodiments, the network node is further configured to receive, from the WD, a request requesting the satellite footprint information of one or more close neighbor cells, each one of the one or more close neighbor cells being at a distance from the cell that is less than a predetermined distance threshold.

In some embodiments, the network node is further configured to receive, from the WD, a WD location and selecting a list of the one or more close neighbor cells based on the WD location.

In some other embodiments, the network node is further configured to transmit a WD configuration including the predetermined distance threshold and a predetermined elevation angle threshold different from broadcasted in system information.

In some embodiments, the WD is an internet of things, IoT, NTN device and the network node is an NTN satellite.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 shows an example RLF and RRC connection re-establishment;

FIG. 2 shows an example architecture of a satellite network with bent pipe transponders;

FIG. 3 shows an example of a diurnal Doppler shift of the forward service link observed for a GEO satellite operating from an inclined orbit;

FIG. 4 shows example orbital elements;

FIG. 5 is a schematic diagram of an example network architecture illustrating a communication system connected via an intermediate network to a host computer according to the principles in the present disclosure;

FIG. 6 is a block diagram of a host computer communicating via a network node with a wireless device over an at least partially wireless connection according to some embodiments of the present disclosure;

FIG. 7 is a flowchart illustrating example methods implemented in a communication system including a host computer, a network node and a wireless device for executing a client application at a wireless device according to some embodiments of the present disclosure;

FIG. 8 is a flowchart illustrating example methods implemented in a communication system including a host computer, a network node and a wireless device for receiving user data at a wireless device according to some embodiments of the present disclosure;

FIG. 9 is a flowchart illustrating example methods implemented in a communication system including a host computer, a network node and a wireless device for receiving user data from the wireless device at a host computer according to some embodiments of the present disclosure;

FIG. 10 is a flowchart illustrating example methods implemented in a communication system including a host computer, a network node and a wireless device for receiving user data at a host computer according to some embodiments of the present disclosure;

FIG. 11 is a flowchart of an example process in a network node according to some embodiments of the present disclosure;

FIG. 12 is a flowchart of an example process in a wireless device according to some embodiments of the present disclosure;

FIG. 13 is a flowchart of an example process in a wireless device according to some embodiments of the present disclosure; and

FIG. 14 is a flowchart of an example process in a network node according to some embodiments of the present disclosure.

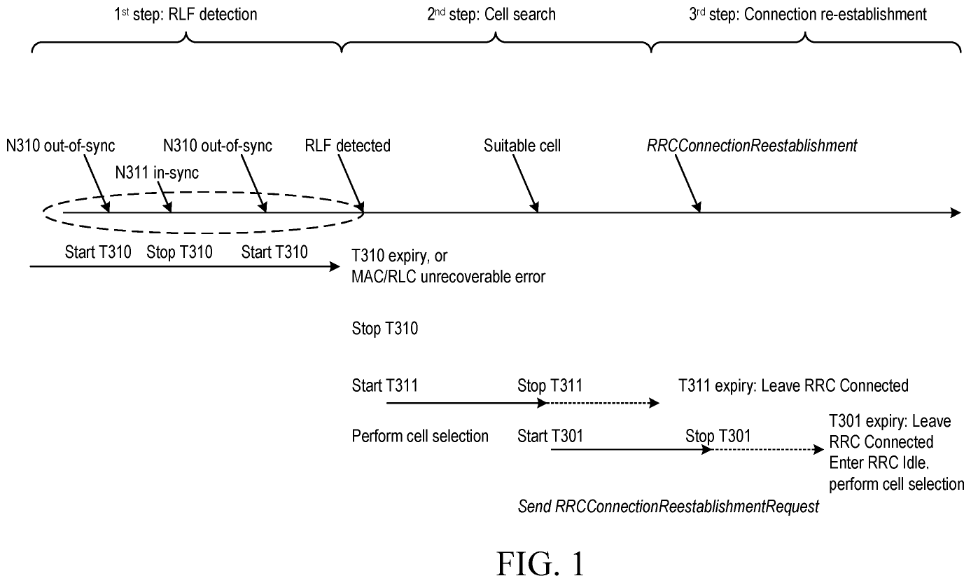

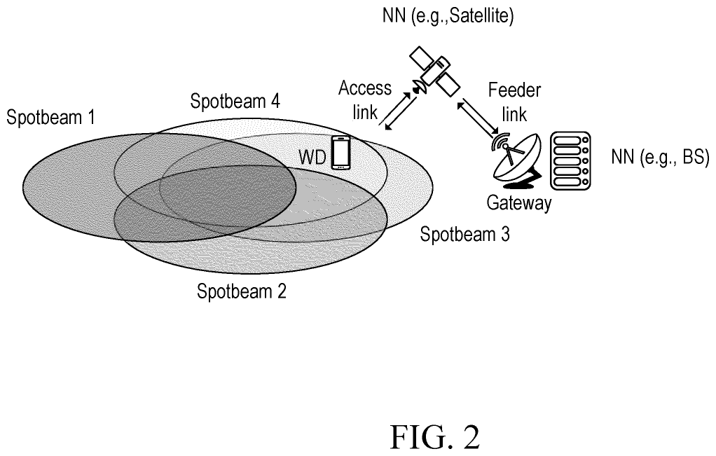

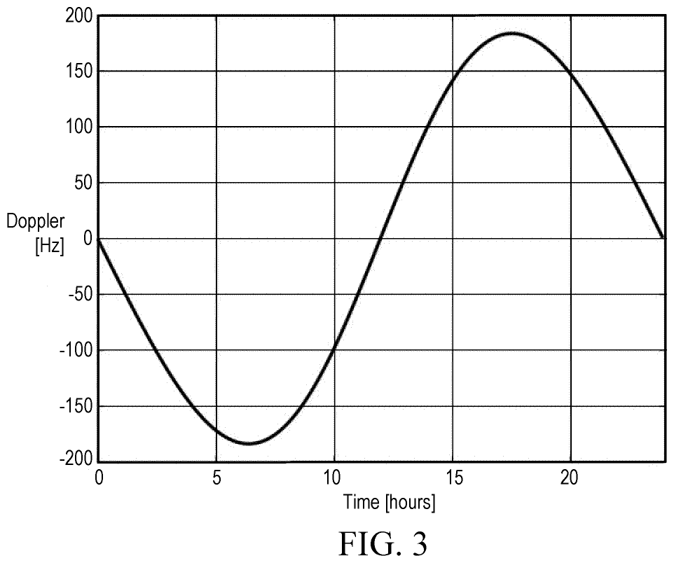

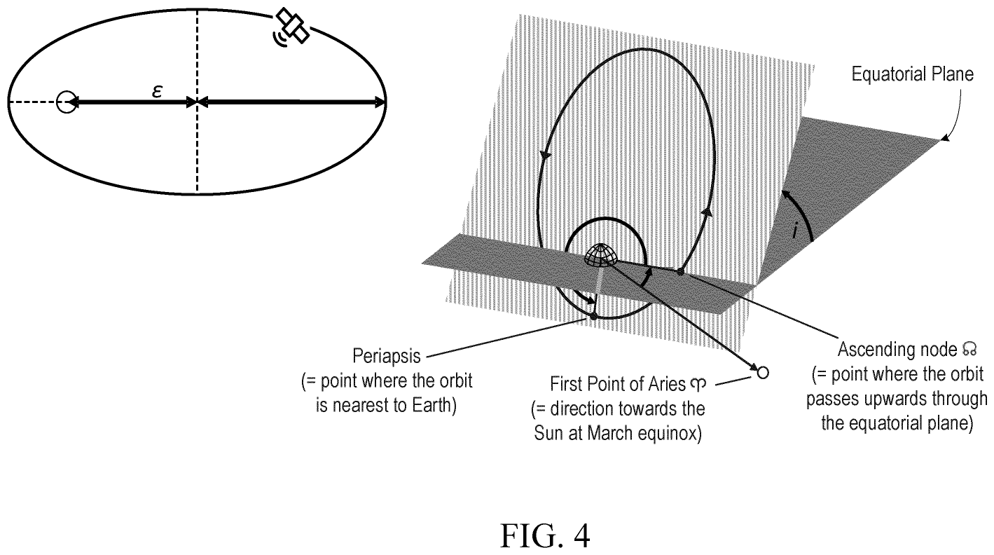

### DETAILED DESCRIPTION

Before describing in detail example embodiments, it is noted that the embodiments reside primarily in combinations of apparatus components and processing steps related to cell measurements associated with internet of things (IoT) wireless devices (WDs) and/or network nodes operating in non-terrestrial networks (NTN). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), a satellite, radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system.

Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In addition, one or more of the following notes may be applicable:
Note 1: The embodiments described herein may be described in terms of LTE based (including IoT) NTNs, but they are equally applicable in an NTN based on NR (including IoT) technology.
Note 2: The term “network” is used in the solution description to refer to a network node, which typically will be an eNB (e.g., in an LTE based NTN), but which may also be a gNB (e.g., in a NR based NTN), or a base station or an access point in another type of network, or any other network node with the ability to directly or indirectly communicate with a WD.
Note 3: GNSS may have an important role to play in the proposed solutions such as American Global Positioning System (GPS) and/or other similar systems (e.g., Russian Global Navigation Satellite System (GLONASS), the Chinese BeiDou Navigation Satellite System and the European Galileo.
Note 4: The terms “connected mode”, “RRC_CONNECTED state” or “RRC_CONNECTED mode”may be used interchangeably in this document.
Note 5: The terms satellite footprint information and satellite assistance information (SAI) refers to information (e.g., the minimum necessary information) that allows a WD to determine the size and location on Earth of an NTN cell. In cases of earth fixed cells, this information includes but is not limited to cell radius and cell reference location. In case of earth-moving cells, this information includes but is not limited to satellite ephemeris, minimum elevation angles, as described in SIB32, cell radius and/or cell reference location offset with respect to satellite nadir (e.g., for beams that are not evenly distributed around nadir and might have a certain inclination).
Note 6: The RRC timer T326 may govern when a NB-IoT WD might perform intra and inter frequency measurements in RRC_CONNECTED whenever the criteria, e.g., specified in section 5.5.8 “Measurements in NB-IoT” in 3GPP TS 36.331 V17.1.0, is also fulfilled. The criteria may be based on measured RSRP and was established to prevent stationary WDs to perform unnecessary measurements in RRC_CONNECTED.
Note 7: the value of t-service-r17 may sometimes be referred to as “remaining service time” or “current cell stop serving time”. This parameter informs the WD when the satellite (normally operating in a LEO or MEO) that is serving the cell to which the WD is connected will stop serving the area due to its movement.
Note 8: the term GNSS validity timer may refer to an IoT NTN specific value transmitted by a WD in Msg5 that informs the network of the estimated remaining duration of a GNSS location measurement. This way, a stationary WD may report “infinity” as the remaining duration, while for a moving WD might only be a few seconds. This was introduced in Rel-17 to assist the network in scheduling IoT NTN WDs, given that they are unable to obtain a GNSS measurements while in connected mode.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

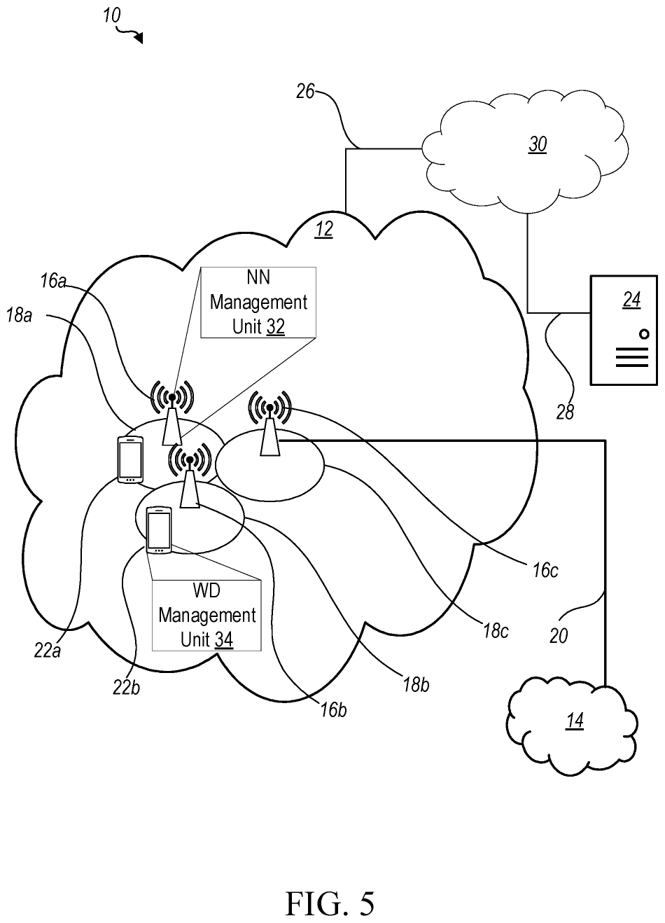

Referring again to the drawing figures, in which like elements are referred to by like reference numerals, there is shown in FIG. 5 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). A coverage area 18 may be served by one or more cells (e.g., serving cells). In some embodiments, the terms cell and coverage area may be used interchangeably. Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 5 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a NN management unit 32 which is configured to perform any step and/or task and/or process and/or method and/or feature described in the present disclosure, e.g., determine information usable to trigger the WD to perform at least one action associated with a cell selection process and a radio link failure. A wireless device 22 is configured to include a WD management unit 34 which is configured to perform any step and/or task and/or process and/or method and/or feature described in the present disclosure, e.g., perform at least one action associated with a cell selection process and a radio link failure based at least in part on received information.

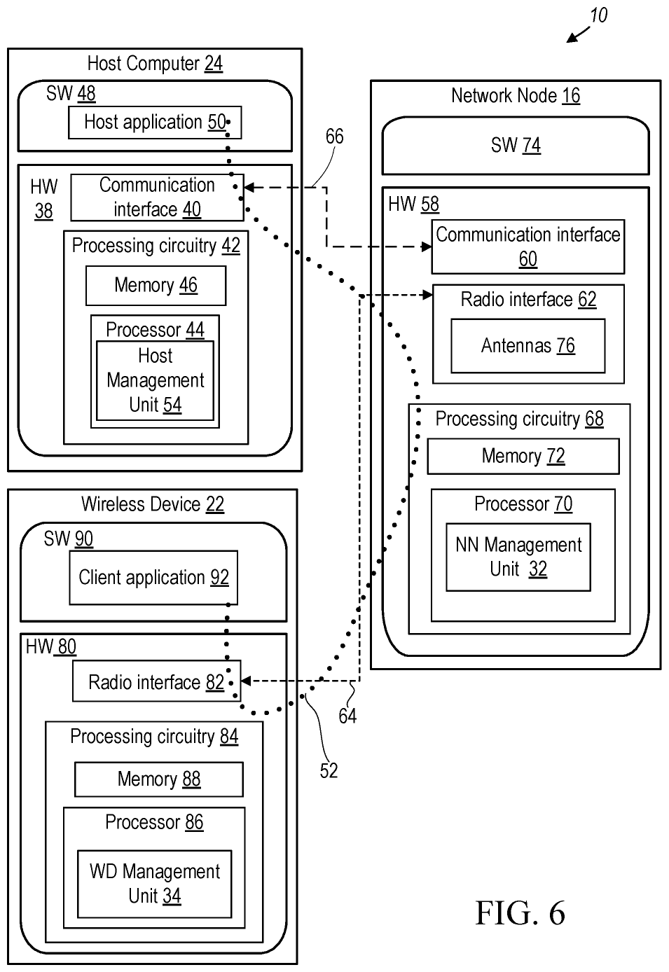

Example implementations, in accordance with an embodiment, of the WD 22, network node 16 and host computer 24 discussed in the preceding paragraphs will now be described with reference to FIG. 6. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a host management unit 54 configured to enable the service provider to perform any step and/or task and/or process and/or method and/or feature described in the present disclosure, e.g., /serve/monitor/ control/transmit to/receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include NN management unit 32 configured to perform any step and/or task and/or process and/or method and/or feature described in the present disclosure, e.g., determine information usable to trigger the WD to perform at least one action associated with a cell selection process and a radio link failure.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD management unit 34 configured to perform any step and/or task and/or process and/or method and/or feature described in the present disclosure, e.g., perform at least one action associated with a cell selection process and a radio link failure based at least in part on received information.

In some embodiments, the inner workings of the network node 16, WD 22, and host computer 24 may be as shown in FIG. 6 and independently, the surrounding network topology may be that of FIG. 5.

In FIG. 6, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc. ; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 5 and 6 show various “units” such as NN management unit 32, and WD management unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

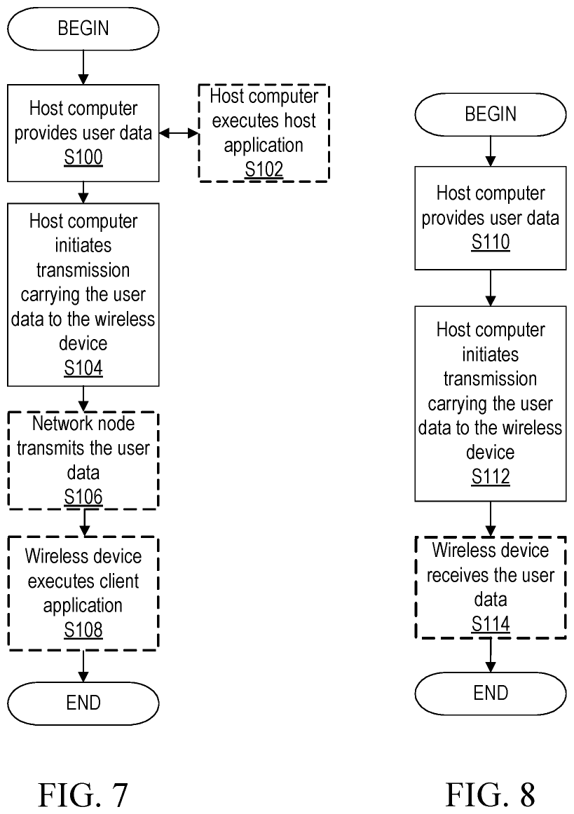

FIG. 7 is a flowchart illustrating an example method implemented in a communication system, such as, for example, the communication system of FIGS. 5 and 6, in accordance with one embodiment. The communication system may include a host computer 24, a network node 16 and a WD 22, which may be those described with reference to FIG. 6. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 8 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

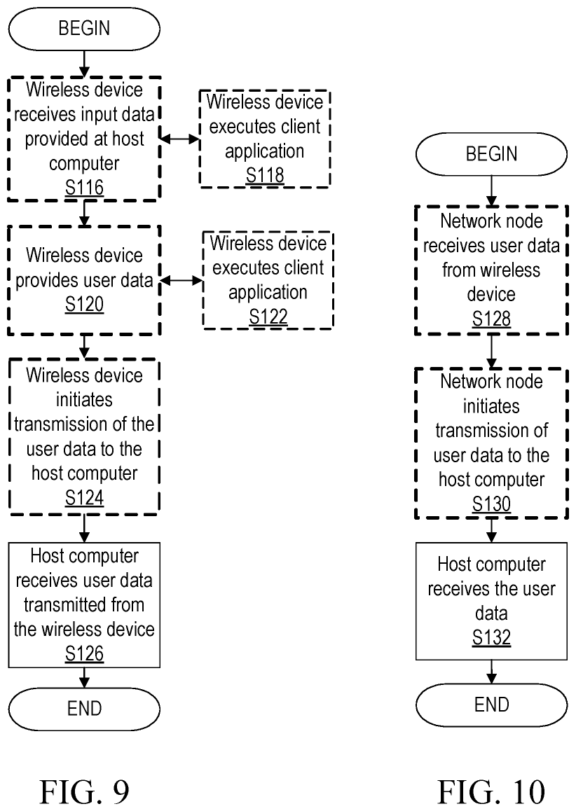

FIG. 9 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118).

Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 10 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

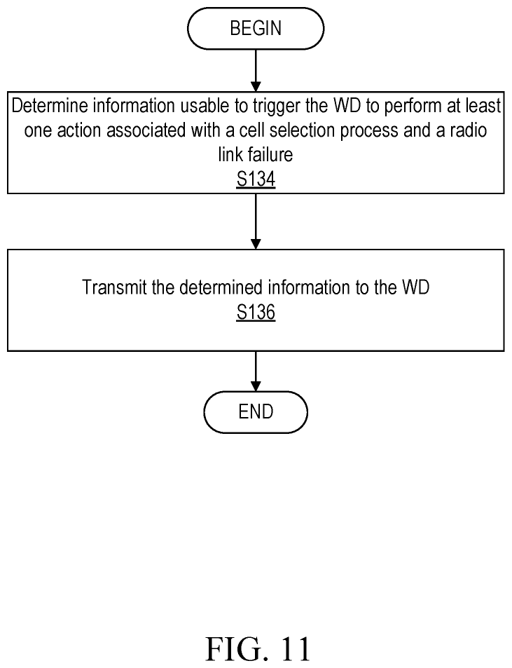

FIG. 11 is a flowchart of an example process in a network node 16. One or more blocks described herein may be performed by one or more elements of network node 16 such as by one or more of processing circuitry 68 (including the NN management unit 32), processor 70, radio interface 62 and/or communication interface 60. Network node 16 such as via processing circuitry 68 and/or processor 70 and/or radio interface 62 and/or communication interface 60 is configured to determine (Block S134) information usable to trigger the WD 22 to perform at least one action associated with a cell selection process and a radio link failure; and transmit (Block S136) the determined information to the WD 22.

In some embodiments, the determined information includes at least one of: an indication indicating a serving cell will stop serving; at least one of a time threshold and a distance threshold associated with a cell; cell information; and satellite footprint information.

In some other embodiment, the at least one action includes: a cell measurement, the cell measurement being at least one of an intra-frequency cell measurement and an inter-frequency cell measurement; a start of a timer associated with the cell measurement; and a selection of at least another cell based at least on one of the determined information, the cell measurement, and a time associated with the timer.

In one embodiment, the at least another cell is selected, as part of the cell selection process, when the WD 22 is in a connected mode and before to the radio link failure is declared.

In another embodiment, at least one of the WD 22 is an IoT WD and the wireless communication network comprises a non-terrestrial network.

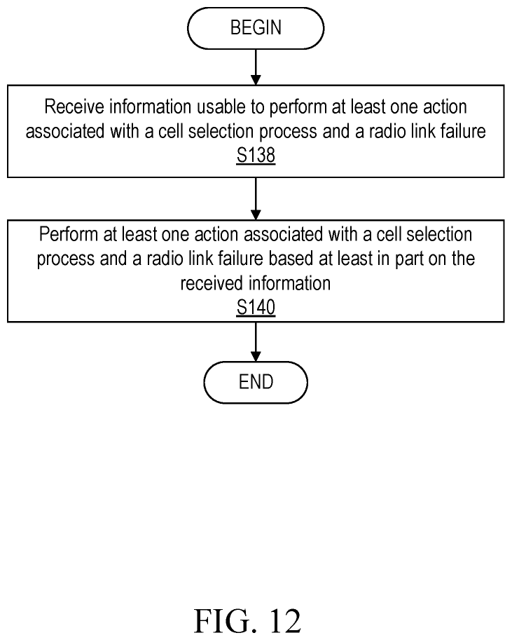

FIG. 12 is a flowchart of an example process in a wireless device 22 according to some embodiments of the present. One or more blocks described herein may be performed by one or more elements of wireless device 22 such as by one or more of processing circuitry 84 (including the WD management unit 34), processor 86, radio interface 82 and/or communication interface 60. Wireless device 22 such as via processing circuitry 84 and/or processor 86 and/or radio interface 82 is configured to receive (Block S138) information usable to perform at least one action associated with a cell selection process and a radio link failure; and perform (Block S140) at least one action associated with a cell selection process and a radio link failure based at least in part on the received information. In some embodiments, the received information includes at least one of: an indication indicating a serving cell will stop serving; at least one of a time threshold and a distance threshold associated with a cell; cell information; and satellite footprint information.

In some other embodiments, the at least one action includes: a cell measurement, the cell measurement being at least one of an intra-frequency cell measurement and an inter-frequency cell measurement; a start of a timer associated with the cell measurement; and a selection of at least another cell based at least on one of the determined information, the cell measurement, and a time associated with the timer.

In an embodiment, the at least another cell is selected, as part of the cell selection process, when the WD 22 is a connected mode and before the radio link failure is declared.

In another embodiment, the method further includes triggering the cell measurement to be performed when the WD 22 is served by one or more quasi-earth fixed cells, a distance from the WD 22 to a cell border is less than a predetermined value, and a threshold has not been exceeded,

In some embodiments, the method further includes triggering the cell measurement to be performed when the WD 22 is served by one or more earth-moving cells, an elevation angle associated with a satellite of the wireless communication network decreases, and another threshold has been exceeded.

In some other embodiments, at least one of the WD 22 is an IoT WD and the wireless communication network comprises a non-terrestrial network.

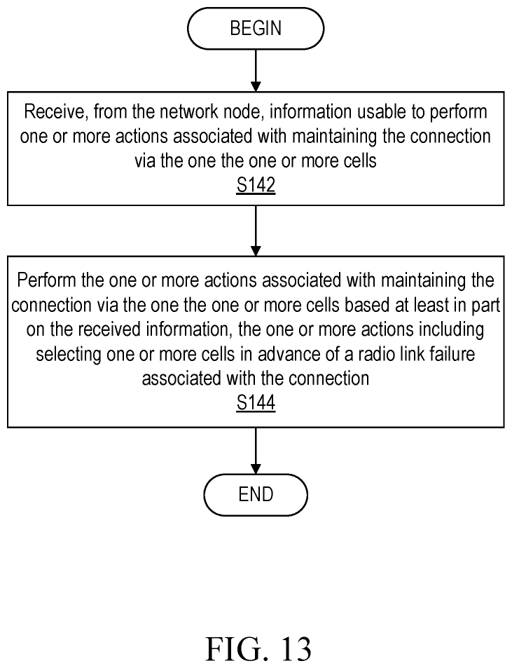

FIG. 13 is a flowchart of an example process in a wireless device 22 according to some embodiments of the present. One or more blocks described herein may be performed by one or more elements of wireless device 22 such as by one or more of processing circuitry 84 (including the WD management unit 34), processor 86, radio interface 82 and/or communication interface 60. Wireless device 22 such as via processing circuitry 84 and/or processor 86 and/or radio interface 82 is configured to receive (Block S142), from the network node 16, information usable to perform one or more actions associated with maintaining the connection via the one the one or more cells perform (Block S144) the one or more actions associated with maintaining the connection via the one the one or more cells based at least in part on the received information. The one or more actions include selecting one or more cells in advance of a radio link failure associated with the connection.

In some embodiments, the information includes a remaining service time indicating when a cell of the one or more cells that is serving the WD 22 will stop serving the WD 22. The one or more actions include, when the WD 22 is in a connected mode, one or both of determining, based on the remaining service time, to start a timer (T326) that indicates when the WD 22 is to perform cell measurements during a connected mode and performing the cell measurements.

In some other embodiments, the one or more actions include, based on the remaining service time, one or both of adjusting the timer (T326) and skipping the performing of the cell measurements.

In some embodiments, the information includes a time threshold. The one or more actions include activating the timer (T326) when the WD 22 receives the time threshold.

In some other embodiments, the information further includes satellite footprint information. The one or more actions include, based on the satellite footprint information, determining a proximity metric indicating a proximity of the WD 22 to the cell and determining whether the WD 22 is moving towards the cell. The one or more actions may include, based on the proximity metric and whether the WD 22 is moving towards the cell, activating the timer (T326) and performing the cell measurements.

In some embodiments, when the cell is a quasi earth fixed cell, the satellite footprint information includes one or more of a first cell radius, a cell reference location, a second cell radius in an along-track direction and a third cell radius in a cross-track direction. The received information includes one or both of a first threshold indicating one or more of a distance from a reference location, a first time variance of the distance to the reference location, a second time variance between WD location measurements, a percentage of radius; and the reference location for neighboring cells and one or more distance thresholds. When the cell is an earth moving cell, the satellite footprint information includes one or more of a fourth cell radius and one or two elevation angles, the received information includes one or both of one or more elevation angles measured from the WD 22 to a satellite and time variance of the one or more elevation angles.

In some other embodiments, the one or more actions include, based on the satellite footprint information and whether the cell is the quasi earth fixed cell or the earth moving cell and, one or more of activating the timer (T326), performing the cell measurements, and maintaining a reference power level without updates.

In some embodiments, the one or more actions include obtaining the satellite footprint information for the satellite and neighbor satellites when the WD 22 experiences discontinuous coverage. If an upcoming coverage gap is not detected, the one or more actions include one or both of activating the timer (T326) and determining when to perform neighbor cell measurements.

In some other embodiments, the one or more actions include one or more of transmitting, to the network node 16, a request requesting the satellite footprint information of one or more close neighbor cells, where each one of the one or more close neighbor cells are at a distance from the cell that is less than a predetermined distance threshold, transmitting, to the network node 16, a WD location for the network node 16 to select a list of the one or more close neighbor cells, and receiving a WD configuration including the predetermined distance threshold and a predetermined elevation angle threshold different from broadcasted in system information.

In some embodiments, the WD 22 is an internet of things (IoT) NTN device, and the network node 16 is an NTN satellite.

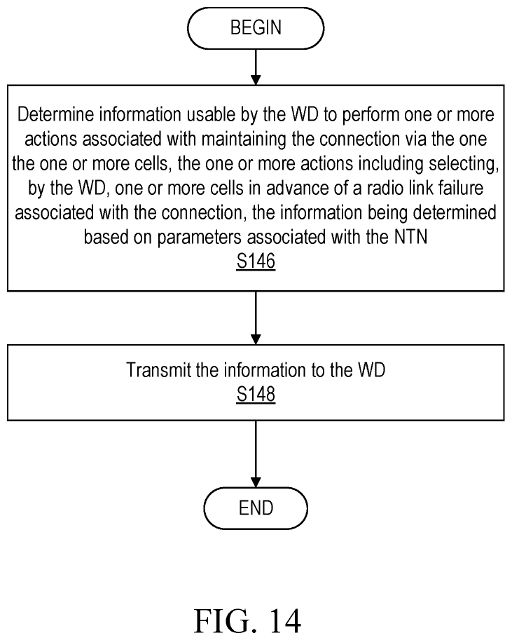

FIG. 14 is a flowchart of an example process in a network node 16. One or more blocks described herein may be performed by one or more elements of network node 16 such as by one or more of processing circuitry 68 (including the NN management unit 32), processor 70, radio interface 62 and/or communication interface 60. Network node 16 such as via processing circuitry 68 and/or processor 70 and/or radio interface 62 and/or communication interface 60 is configured to determine (Block S146) information usable by the WD 22 to perform one or more actions associated with maintaining the connection via the one the one or more cells. The one or more actions include selecting, by the WD 22, one or more cells in advance of a radio link failure associated with the connection. The information is determined based on parameters associated with the NTN. Network node 16 is further configured to transmit (Block S148) the information to the WD 22.

In some embodiments, the information includes a remaining service time indicating when a cell of the one or more cells that is serving the WD 22 will stop serving the WD 22, the remaining service time being usable by the WD 22 for starting a timer (T326) that indicates when the WD 22 is to perform cell measurements during a connected mode.

In some other embodiments, the information includes a time threshold usable by the WD 22 for determining when to activate the timer (T326).

In some embodiments, the information further includes satellite footprint information usable by the WD 22 for determining a proximity metric indicating a proximity of the WD 22 to the cell, determining whether the WD 22 is moving towards the cell, activating the timer (T326), and performing the cell measurements.

In some other embodiments, when the cell is a quasi earth fixed cell, the satellite footprint information includes one or more of a first cell radius, a cell reference location, a second cell radius in an along-track direction and a third cell radius in a cross-track direction; the transmitted information includes one or both of a first threshold indicating one or more of a distance from a reference location, a first time variance of the distance to the reference location, a second time variance between WD location measurements, a percentage of radius; and the reference location for neighboring cells and one or more distance thresholds.

In some embodiments, when the cell is an earth moving cell, the satellite footprint information includes one or more of a fourth cell radius and one or two elevation angles, and the transmitted information includes one or both of one or more elevation angles measured from the WD 22 to a satellite, and time variance of the one or more elevation angles.

In some other embodiments, the method further includes receiving, from the WD 22, a request requesting the satellite footprint information of one or more close neighbor cells, each one of the one or more close neighbor cells being at a distance from the cell that is less than a predetermined distance threshold.

In some embodiments, the method further includes receiving, from the WD 22, a WD location and selecting a list of the one or more close neighbor cells based on the WD location.

In some other embodiments, the method further includes transmitting a WD configuration including the predetermined distance threshold and a predetermined elevation angle threshold different from broadcasted in system information.

In some embodiments, the WD 22 is an internet of things, IoT, NTN device and the network node 16 is an NTN satellite.

Having described the general process flow of arrangements of the disclosure and having provided examples of hardware and software arrangements for implementing the processes and functions of the disclosure, the sections below provide details and examples of arrangements for cell measurements associated with internet of things (IoT) wireless devices (WDs) 22 and/or network nodes 16 operating in non-terrestrial networks (NTN). In one embodiment, a WD 22 in RRC_CONNECTED (i.e., a connected mode) may use the information provided by the network node 16 which indicates when current cell will stop serving, e.g., t-service-r 17 broadcast in SystemInformationBlock3(-NB), to start T326 (i.e., a timer) and/or perform intra or inter-frequency cell measurements. For example, a WD 22 may apply a value to (e.g., a larger or lower value to) T326 and/or skip measurements depending on the remaining serving time. In one or more embodiments, the network node 16 may also provide a certain time threshold such as via broadcast, e.g., system information, dedicated signaling, which the WD 22 may use to activate T326 and/or perform measurements.

In another embodiment, the network node 16 may be configured to provide satellite footprint information (such as in SIB3(-NB), SIB31(-NB), a new SIB, dedicated RRC signaling). A WD 22 may be configured to use this information and/or its own (determined/estimated) location to determine whether WD 22 is close to (i.e., within a predetermined distance of) the cell border, moving towards the cell border. Further, the WD may use the information to activate T326 and/or start measuring accordingly. The network node 16 may configure a determined threshold, as described below, to trigger a WD action. In case of quasi earth-fixed cells, the satellite footprint information may include cell radius, cell reference location (in geodetic coordinates), and/or a combination of cell radius in the satellite along-track direction and/or a radius in the cross-track direction (when the cell footprint has a quasi-elliptical or oval shape). The network node 16 provided/determined threshold may be a distance from the reference location, the time variance of the distance to the reference location, between WD 22 location measurements, and/or a percentage of the radius, etc. In one or more embodiments, the network node 16 may be configured to provide the reference location for neighboring cells and/or one or more distance thresholds. In cases of earth-moving cells, the satellite footprint information may include the cell radius and/or one or two elevation angles. The network node 16 provided threshold may be a certain elevation angle(s) measured from the WD 22 to the satellite and/or the time variance of the elevation angle(s).

Further, a WD 22 may be configured to make a decision (e.g., determine) to start T326 and/or start measurements based on a combination of the above-mentioned criteria. For example, in cases of quasi-earth fixed cells, a WD 22 that is close to the cell border and is above a certain threshold can start measurements. Another WD 22 close to the cell border where WD distance to the cell reference location does not change with time (distance time variation) or does not change (e.g., change significantly) with respect to t-service-r 17 (serving cell stop time) may be considered stationary. A stationary WD may choose not to perform connected mode measurements. In cases of earth-moving cells, in another example, when the satellite and WD 22 are moving away from each other, the elevation angle may drop (e.g., rapidly once past the satellite nadir). The WD 22 above a certain threshold may trigger/perform measurements. In contrast, when the satellite and WD 22 move along a similar direction, the elevation angle may fluctuate (e.g., slowly), and the WD 22 may choose to postpone measurements and/or consider other limiting conditions such as the RSRP variation and/or the stop serving time (t-service-r 17). The WD 22 may also leverage broadcast satellite ephemeris to assist in these calculations/determinations, e.g., by using a Keplerian two-body propagator to estimate the satellite's future position and know its movement direction.

In yet another embodiment, a combination of time and location criteria described in the previous embodiment may be used to enhance (N)RSRP criteria, e.g., specified in section 5.5.8 in 3GPP TS 36.331 V17.1.0. For instance, a WD 22 may not update its (N)RSRP reference power level as long as it complies with a certain distance and/or time criteria. This can assist to filter out fluctuations in the measured (N)RSRP induced by the satellite movement and limit measurements. In addition, it permits to establish a tighter power criterion (s-MeasureDeltaP), i.e., lower values than in terrestrial networks that are adapted to the relatively small power drop that exist between the cell center and its border in NTN.

In another embodiment, a combination of time and location criteria may be used to activate T326, set its value to a certain value, scale its value, and/or start performing measurements without considering the power criteria. For example, a WD 22 moving away from the cell border, i.e., with a decreasing distance from the cell reference location, may choose to perform measurements if the remaining service time (t-service-r17) is below a certain threshold and/or close to an end.

In one embodiment, a WD 22 in a discontinuous coverage scenario (i.e., supporting/experiencing discontinuous coverage) may obtain, via SIB32 and/or SIB32-NB, satellite footprint information for the serving and neighbor satellites. The WD 22 may use this information to activate T326 or decide when to perform neighbor cell measurements (e.g., unless an upcoming coverage gap is detected (i.e., a period without network coverage)).

In another embodiment, a WD 22 may request via RRC, e.g., using a new parameter in RRCConnectionReestablishmentRequest, the satellite footprint information of the closest neighbors to the serving cell. The WD 22 may leverage this data to activate T326 and/or decide when to perform neighbor cell measurements. In one or more embodiments, the WD 22 might report its precise and/or coarse location to assist the network node 16 in selecting a list of closest neighbors to which the WD 22 is more likely to move. In one embodiment, the network node 16 may configure WD 22 via an RRC message with a specific distance or elevation angle threshold different from the one broadcast in System Information. The network node 16 may leverage other information such as the GNSS validity timer to configure the WD-specific threshold. This may be useful to avoid measurements in WDs 22 moving close to and/or along the cell border where the WDs 22 are not likely to move away from the cell and, thus, declare RLF.

The following is a nonlimiting list of example embodiments.

Embodiment A1. A network node configured to communicate with a wireless device, WD, using a wireless communication network, the network node configured to, and/or comprising a radio interface and/or comprising processing circuitry configured to:
determine information usable to trigger the WD to perform at least one action associated with a cell selection process and a radio link failure; and
transmit the determined information to the WD.

Embodiment A2. The network node of Embodiment A1, wherein the determined information includes at least one of:
an indication indicating a serving cell will stop serving;
at least one of a time threshold and a distance threshold associated with a cell;
cell information; and
satellite footprint information.

Embodiment A3. The network node of any one of Embodiments A1 and A2, wherein the at least one action includes:
a cell measurement, the cell measurement being at least one of an intra-frequency cell measurement and an inter-frequency cell measurement;
a start of a timer associated with the cell measurement; and
a selection of at least another cell based at least on one of the determined information, the cell measurement, and a time associated with the timer.

Embodiment A4. The network node of Embodiment A3, wherein the at least another cell is selected, as part of the cell selection process, when the WD is a connected mode and before the radio link failure is declared.

Embodiment A5. The network node of any one of Embodiments A1-A4, wherein at least one of:
The Wd Is an Iot Wd; and
the wireless communication network comprises a non-terrestrial network.

Embodiment B1. A method in a network node configured to communicate with a wireless device, WD, using a wireless communication network, the method comprising:
determining information usable to trigger the WD to perform at least one action associated with a cell selection process and a radio link failure; and
transmitting the determined information to the WD.

Embodiment B2. The method of Embodiment B1, wherein the determined information includes at least one of:
an indication indicating a serving cell will stop serving;
at least one of a time threshold and a distance threshold associated with a cell; cell information; and
satellite footprint information.

Embodiment B3. The method of any one of Embodiments B1 and B2, wherein the at least one action includes:
a cell measurement, the cell measurement being at least one of an intra-frequency cell measurement and an inter-frequency cell measurement;
a start of a timer associated with the cell measurement; and
a selection of at least another cell based at least on one of the determined information, the cell measurement, and a time associated with the timer.

Embodiment B4. The method of Embodiment B3, wherein the at least another cell is selected, as part of the cell selection process, when the WD is a connected mode and before the radio link failure is declared.

Embodiment B5. The method of any one of Embodiments B1-B4, wherein at least one of:
The Wd Is an Iot Wd; and
the wireless communication network comprises a non-terrestrial network.

Embodiment C1. A wireless device, WD, configured to communicate with a network node using a wireless communication network, the WD configured to, and/or comprising a radio interface and/or processing circuitry configured to:
receive information usable to perform at least one action associated with a cell selection process and a radio link failure; and
perform at least one action associated with a cell selection process and a radio link failure based at least in part on the received information.

Embodiment C2. The WD of Embodiment C1, wherein the received information includes at least one of:
an indication indicating a serving cell will stop serving;
at least one of a time threshold and a distance threshold associated with a cell; cell information; and
satellite footprint information.

Embodiment C3. The WD of any one of Embodiments C1 and C2, wherein the at least one action includes:
a cell measurement, the cell measurement being at least one of an intra-frequency
cell measurement and an inter-frequency cell measurement;
a start of a timer associated with the cell measurement; and
a selection of at least another cell based at least on one of the determined information, the cell measurement, and a time associated with the timer.

Embodiment C4. The WD of Embodiment C3, wherein the at least another cell is selected, as part of the cell selection process, when the WD is a connected mode and before the radio link failure is declared.

Embodiment C5. The WD of any one of Embodiments C3 and C4, wherein the processing circuitry is configured to, when the WD is served by one or more quasi-earth fixed cells, a distance from the WD to a cell border is less than a predetermined value, and a threshold has not been exceeded:
trigger the cell measurement to be performed.

Embodiment C6. The WD of any one of Embodiments C3-C5, wherein the processing circuitry is configured to, when the WD is served by one or more earth-moving cells, an elevation angle associated with a satellite of the wireless communication network decreases, and another threshold has been exceeded:
trigger the cell measurement to be performed.

Embodiment C7. The WD of any one of Embodiments C1-C4, wherein at least one of:
The Wd Is an Iot Wd; and
the wireless communication network comprises a non-terrestrial network.

Embodiment D1. A method in a wireless device, WD, configured to communicate with a network node using a wireless communication network, the method comprising:
receiving information usable to perform at least one action associated with a cell selection process and a radio link failure; and
performing at least one action associated with a cell selection process and a radio link failure based at least in part on the received information.

Embodiment D2. The method of Embodiment D1, wherein the received information includes at least one of:
an indication indicating a serving cell will stop serving;
at least one of a time threshold and a distance threshold associated with a cell;
cell information; and
satellite footprint information.

Embodiment D3. The method of any one of Embodiments D1 and D2, wherein the at least one action includes:
a cell measurement, the cell measurement being at least one of an intra-frequency cell measurement and an inter-frequency cell measurement;
a start of a timer associated with the cell measurement; and
a selection of at least another cell based at least on one of the determined information, the cell measurement, and a time associated with the timer.

Embodiment D4. The method of Embodiment D3, wherein the at least another cell is selected, as part of the cell selection process, when the WD is a connected mode and before the radio link failure is declared.

Embodiment D5. The method of any one of Embodiments D3 and D4, wherein the method further includes, when the WD is served by one or more quasi-earth fixed cells, a distance from the WD to a cell border is less than a predetermined value, and a threshold has not been exceeded:
triggering the cell measurement to be performed.

Embodiment D6. The method of any one of Embodiments D3-D5, wherein the processing circuitry is configured to, when the WD is served by one or more earth-moving cells, an elevation angle associated with a satellite of the wireless communication network decreases, and another threshold has been exceeded:
triggering the cell measurement to be performed.

Embodiment D7. The method of any one of Embodiments D1-D4, wherein at least one of:
The Wd Is an Iot Wd; and
the wireless communication network comprises a non-terrestrial network.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
3GPP 3rd Generation Partnership Project
5G 5th Generation
5GC 5G Core
BS Base Station
CHO Conditional Handover
CLI Cross Link Interference
CN Core Network
CP Control Plane
CPC Conditional PSCell Change
CSI-RS Channel State Information-Reference Signal
CU Central Unit
DAPS Dual Active Protocol Stack
DL Downlink
DU Distributed Unit
eNB Evolved NodeB (LTE base station)
EPC Evolved Packet Core
EUTRA Evolved Universal Terrestrial Radio Access
F1 The interface between a CU and a DU in a gNB.
FDD Frequency Division Duplex
FR1 Frequency Range 1
GEO Geostationary Orbit
gNB Base station in NR.
GNSS Global Navigation Satellite System
GPS Global Positioning System
HAPS High Altitude Platform System
HD-FDD Half Duplex FDD
HO Handover
IE Information Element
IS In-sync
LEO Low Earth Orbit
LTE Long Term Evolution
MAC Medium Access Control
MEO Medium Earth Orbit
NAS Non-Access Stratum
NB-IoT Narrowband Internet of Things
NG The interface between NG-RAN and 5GC. (Also: “Next Generation”.)
NGc The control plane part of the NG interface.
NG-RAN Next Generation RAN
NGu The user plane part of the NG interface.
NPBCH Narrowband Physical Broadcast Channel
NPDCCH Narrowband Physical Downlink Control Channel
NPDSCH Narrowband Physical Downlink Shared Channel
NPRACH Narrowband Physical Random Access Channel
NPSS Narrowband Primary Synchronization Sequence
NR New Radio
NRS Narrowband Reference Signals
NTN Non-Terrestrial Network
NSSS Narrowband Secondary Synchronization Sequence
PCell Primary Cell
PDCCH Physical Downlink Control Channel
PDCP Packet Data Convergence Protocol
PHY Physical layer
PLMN Public Land Mobile Network
PSCell Primary Secondary Cell
RACH Random Access Channel
RAN Radio Access Network
RAN1 3GPP TSG-RAN WG1
RAN2 3GPP TSG-RAN WG2
RAN3 3GPP TSG-RAN WG3
RAT Radio Access Technology
RF Radio Frequency
RLC Radio Link Control
RNL Radio Network Layer
RRC Radio Resource Control
RRM Radio Resource Management
RSRP Reference Signal Received Power
RSRQ Reference Signal Received Quality
RSSI Reference Signal Strength Indicator
RX Receive/Receiver/Reception
SCell Secondary Cell
SIB System Information Block
SINR Signal to Interference and Noise Ratio
SMTC SSB Measurement Timing Configuration
SN Sequence Number
SNPN Stand-alone Non-Public Network
SNR Signal to noise ratio
SRS Sounding Reference Signal
SSB Synchronization Signal Block
SUL Supplementary Uplink
TA Timing Advance
TDD Time Division Duplex
TNL Transport Network Layer
TR Technical Report
TS Technical Specification
TSG Technical Specification Group
TX Transmit/Transmitter/Transmission
UE User Equipment
UP User Plane
USIM Universal Subscriber Identity Module
VPLMN Visited PLMN
WG Working Group
WGS World Geodetic System
X2 The interface between two eNBs in LTE.
Xn The interface between two gNBs in NR.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-40. (canceled)

41. A method in a wireless device, WD, configured to communicate with a network node of a non-terrestrial network, NTN, using a connection via one or more cells served by the network node, the method comprising:
receiving, from the network node, information usable to perform one or more actions associated with maintaining the connection via the one the one or more cells, the information including a remaining service time indicating when a cell of the one or more cells that is serving the WD will stop serving the WD;
performing the one or more actions while maintaining the connection via the one the one or more cells based on the received information, the information further including satellite footprint information;
based on the satellite footprint information, determining a proximity metric indicating a proximity of the WD to the cell; and
the one or more actions including one of:
starting to perform cell measurements; and
starting a time that indicates when the WD is to perform cell measurements during a connected mode.

42. The method of claim 41, wherein the one or more actions include, based on the remaining service time, one or both of:
adjusting the timer; and
skipping the performing of the cell measurements.

43. The WD of claim 41, wherein the information includes a time threshold, and the one or more actions include:
activating the timer when the WD receives the time threshold.

44. The method of claim 41, wherein the one or more actions include:
determining whether the WD is moving towards the cell; and
based on the proximity metric determining whether the WD is moving towards the cell.

45. The method of Claim wherein:
when the cell is a quasi earth fixed cell, the satellite footprint information includes one or more of:
a cell reference location; and
a first threshold indicating one or more of a distance from a reference location and a first time variance of the distance to the reference location; and
when the cell is an earth moving cell, the satellite footprint information includes:
one or two elevation angles; and
the received information includes one or both of:
one or more elevation angles measured from the WD to a satellite; and
time variance of the one or more elevation angles.

46. The method of claim 45, further comprising, based on the satellite footprint information and whether the cell is the quasi earth fixed cell or the earth moving cell and, one or more of:
activating the timer;
performing the cell measurements; and
maintaining a reference power level without updates.

47. The method of Claim further comprising:
obtaining the satellite footprint information for the satellite and neighbor satellites when the WD experiences discontinuous coverage; and
if an upcoming coverage gap is not detected, one or both of:
activating the timer; and
determining when to perform neighbor cell measurements.

48. The method of Claim further comprising:
transmitting, to the network node, a request requesting the satellite footprint information of one or more close neighbor cells, each one of the one or more close neighbor cells being at a distance from the cell that is less than a predetermined distance threshold;
transmitting, to the network node, a WD location for the network node to select a list of the one or more close neighbor cells; and
receiving a WD configuration including the predetermined distance threshold and a predetermined elevation angle threshold different from broadcasted in system information.

49. The method of claim 41, wherein:
the WD is an internet of things, IoT, NTN device; and
the network node is an NTN satellite.

50. A wireless device, WD, configured to communicate with a network node of a non-terrestrial network, NTN, using a connection via one or more cells served by the network node, the WD being configured to:
receive, from the network node, information usable to perform one or more actions associated with maintaining the connection via the one or more cells, the information including a remaining service time indicating when a cell of the one or more cells that is serving the WD will stop serving the WD;
perform the one or more actions while maintaining the connection via the one or more cells based on the received information, the information further including satellite footprint information;
based on the satellite footprint information, determining a proximity metric indicating a proximity of the WD to the cell; and
the one or more actions includes one of:
starting to perform cell measurements; and
starting a timer, that indicates when the WD is to perform cell measurements during a connected mode.

51. A method in a network node of a non-terrestrial network, NTN, configured to communicate with a wireless device, WD, using a connection via one or more cells served by the network node, the method comprising:
determining information usable by the WD to perform one or more actions associated with maintaining the connection via the one the one or more cells, the information including a remaining service time indicating when a cell of the one or more cells that is serving the WD will stop serving the WD, the remaining service time being usable by the WD for starting a timer that indicates when the WD is to perform cell measurements during a connected mode, the information further including satellite footprint information enabling the WD to determine a proximity metric indicating a proximity of the WD to the cell; and
transmitting the information to the WD.

52. The method of claim 51, wherein the information includes a time threshold usable by the WD for determining when to activate the timer.

53. The method of claims 51, wherein the information further includes satellite footprint information usable by the WD for:
determining a proximity metric indicating a proximity of the WD to the cell;
determining whether the WD is moving towards the cell;
activating the timer; and
performing the cell measurements.

54. method of claim 53, wherein when the cell is a quasi earth fixed cell, the satellite footprint information includes a cell reference location; and
the transmitted information includes one or both of:
a first threshold indicating a distance from a reference location; and
a first time variance of the distance to the reference location.

55. The method of claims 53, wherein when the cell is an earth moving cell, the satellite footprint information includes one or more of one or two elevation angles, and the transmitted information includes one or both of:
one or more elevation angles measured from the WD to a satellite; and
time variance of the one or more elevation angles.

56. The method of claim 53, wherein the method further includes:
receiving, from the WD, a request requesting the satellite footprint information of one or more close neighbor cells, each one of the one or more close neighbor cells being at a distance from the cell that is less than a predetermined distance threshold.

57. The method of claim 56, wherein the method further includes:
receiving, from the WD, a WD location; and
selecting a list of the one or more close neighbor cells based on the WD location.

58. The method of claim 56, wherein the method further includes:
transmitting a WD configuration including the predetermined distance threshold and a predetermined elevation angle threshold different from broadcasted in system information.

59. The method of claim 51, wherein the network node is an NTN satellite.

60. A network node of a non-terrestrial network, NTN, configured to communicate with a wireless device, WD, using a connection via one or more cells served by the network node, the network node being configured to:
determine information usable by the WD to perform one or more actions associated with maintaining the connection via the one the one or more cells, the information including a remaining service time indicating when a cell of the one or more cells that is serving the WD will stop serving the WD, the remaining service time being usable by the WD for starting a timer that indicates when the WD is to perform cell measurements during a connected mode, the information further including satellite footprint information enabling the WD to determine a proximity metric indicating a proximity of the WD to the cell; and
transmit the information to the WD.
